(19) United States
(12) Patent Application Publication
(10) Pub. No.: US 2008/0049912 A1
(43) Pub. Date: Feb. 28, 2008

(54) Method and apparatus for message presentation Via telecommunications network

(76) Inventors: Timothy J. Carter, Andover, MA (US); Robert Walter Carney, Cambridge, MA (US); Christopher C.s. Horn, Pittsburgh, PA (US); Daniel Zachary Tanjeloff, Sarasota, FL (US)

Correspondence Address: WOLF GREENFIELD & SACKS, P.C., 600 ATLANTIC AVENUE, BOSTON, MA, 02210-2206, US

(21) Appl. No.: 11/823,864

(22) Filed: Jun. 28, 2007

Related U.S. Application Data
(60) Provisional application No. 60/817,005, filed on Jun. 28, 2006.

(51) Int. Cl. H04M 1/64; H04M 15/00

(52) U.S. Cl. 379/88.22; 379/114.13

(57) ABSTRACT

A method and apparatus for delivering a message to a caller prior to the moment the recipient unhooks or answers their telephone or other network interface device, as well as optionally delivering a message to the caller, the recipient, or both after the connection between the service provider and the caller, and/or the connection between the service provider and the recipient has been established. The method and apparatus are effective for use with all telecommunications systems, including, but not limited to, optical-based telephone systems, wire-based telephone systems, wireless telephone systems, optical-based computer network systems, wire-based computer network systems, wireless computer network systems, and heterogeneous network systems.

### RELATED APPLICATIONS

This application claims priority to U.S. Provisional Application No. 60/817,005, filed Jun. 28, 2006 which is incorporated herein by reference.

### BACKGROUND OF INVENTION

Today, telecommunication systems are widely used to convey information. Examples of such systems are telephone systems, whether those that provide POTS (Plain Old Telephone Services) or those that provide integrated voice and data or enhanced data services, either over cables or wirelessly. Regardless of the specific technology with which a telecommunications system is built or its intended purpose, such systems allow connections between two or more parties to be established so that information may be exchanged.

The inventors have appreciated that opportunities exist to expand the utility of a wide variety of telecommunication services.

### SUMMARY OF INVENTION

In one aspect, the invention relates to a method of operating a telecommunication system. The method includes receiving a call from a caller, the call being directed to a subscriber, providing a message to the caller prior to establishing a connection between the caller and the subscriber. An incentive for a party authorizing the message is recorded and the connection is established.

In another aspect, the invention relates to a method of operating a telecommunication system for which a sponsor provides promotional information. The method includes receiving a call directed to a subscriber. A message is provided to the caller prior to establishing a connection between the caller and the subscriber. The message has content based on the promotional information. The caller is prompted for input based on the message.

In a further aspect, the invention relates to a method of operating a telecommunication system. The method includes establishing an account associated with a subscriber and recording, in connection with the account, information about a plurality of potential calling parties. When call directed to the subscriber is received from a caller who is one of the plurality of potential calling parties, a message is provided to the caller prior to establishing a connection between the caller and the subscriber, content of the message being based on the information.

### BRIEF DESCRIPTION OF THE DRAWINGS

In the drawings:

FIG. 1 is a flow diagram illustrating an exemplary telecommunications session in an implementation consistent with the principles of the invention;

FIG. 2 is a flow diagram illustrating an exemplary caller interaction portion of a telecommunications session in an implementation consistent with the principles of the invention;

FIG. 2A is a flow diagram illustrating an exemplary process flow if the caller chooses to receive an SMS message in an implementation consistent with the principles of the invention;

FIG. 2B is a flow diagram illustrating an exemplary process flow if the caller chooses to interact with the message provider after communicating with the subscriber/intended subscriber in an implementation consistent with the principles of the invention;

FIG. 2C is a flow diagram illustrating an exemplary process flow if the caller chooses to speak with an agent or representative of the message provider in an implementation consistent with the principles of the invention;

FIG. 2D is a flow diagram illustrating an exemplary process flow if the caller chooses to request additional information be presented immediately in an implementation consistent with the principles of the invention; and

FIG. 3 is a sketch of system for message presentation according to an embodiment of the invention;

FIG. 4 is a flow diagram illustrating an exemplary process for recording information about a plurality of potential calling parties.

### DESCRIPTION OF AN EXEMPLARY EMBODIMENT

This application uses five terms to refer to the parties that are required to describe the invention: (1) Caller, (2) Intended Recipient, (3) Subscriber, (4) Message Provider, and (5) Service Provider. These parties are defined in the context of a system for message presentation, described below.

For clarity, an embodiment of the invention is described in the terms and context of a telephone communication system. Unless otherwise specified, however, the concepts described in such terms are meant to apply to all telecommunications systems in which one party is attempting to communicate with a second party. Sample telecommunications systems include, but are not limited to, wired and wireless telephone communication systems, instant-messaging (IM) communication systems, voice-over-internet protocol communication systems, and heterogeneous communication systems. In no way shall the specific example of the telephone communication system restrict the applicability of this invention to other forms of telecommunication systems.

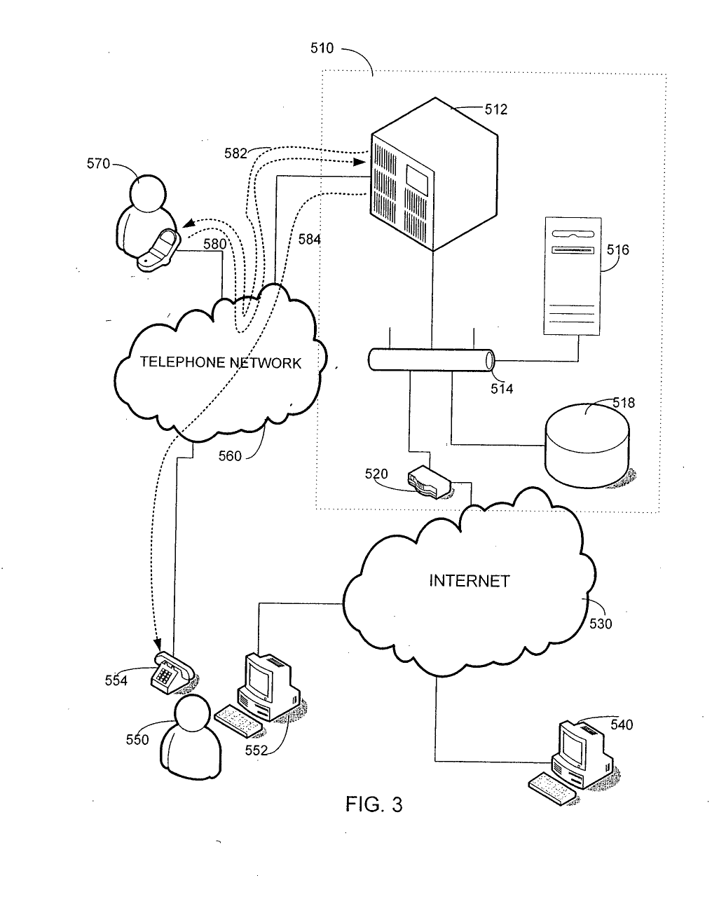

FIG. 3 illustrates a system for presenting messages to callers, such as caller 570. In this embodiment, the messages are presented in audible form. An audible form is suitable for use in connection with a telephone communication system. In other embodiments, the messages may be provided in other forms, including as graphics or video images.

System 510 is configured to intercept a call placed by caller 570 to an intended recipient 550. Caller 570 may place the call through telephone network 560. Telephone network 560 may be a conventional telephone network, such the public switched telephone network. The call may be placed on a landline, over a cellular connection or in any other suitable way.

However, in the embodiment of FIG. 3, the call placed by caller 570 is not routed directly to telephone 554 of the intended recipient. Rather, connection 580 is made through telephone network 560 to system 510. System 510 may then establish a connection 584 to the intended recipient telephone 554. While connection 584 is being established, or at any other suitable time, system 510 may provide a message, indicated by dataflow 582, to caller 570.

In some embodiments, connection 580 is established when caller 570 initiates a call because intended recipient 550 has provided caller 570 with a phone number or other network address that telephone network 560 associates with system 510. However, any suitable means for intercepting a call may be employed.

System 510 is configured to associate an intercepted call with an intended recipient. System 510 may then establish a connection with the intended recipient, in this case also through telephone network 560. System 510 completes the connection between 580 and 584 at the desired time, allowing caller 570 to communicate with intended recipient 550 in a conventional fashion, though the ability of system 510 to communicate with both a caller and an intended recipient may be used to provide different or additional functionality.

To make the required connections, system 510 may be implemented using telephone switching equipment such as a private branch exchange (PBX) 512. PBX 512 may be any suitable PBX or similar telephone switching equipment. In the embodiment illustrated, PBX 512 may be programmed to receive and respond to calls placed to a plurality of telephone numbers. In this example, the telephone number associated with telephone 554 owned by intended recipient 550 is just one example of the plurality of numbers to which PBX 512 responds.

As in a conventional PBX, PBX 512 may be programmed to process each intercepted call. In the example of FIG. 3, PBX 512 is programmed to answers the intercepted call, generate a desired message to caller 570 and establish a connection to telephone 554 of intended recipient 550. The information required by PBX 512 to generate the content in the message sent to caller 570 or to identify telephone 554 of intended recipient 550 may be obtained by PBX 512 in any suitable manner. In the pictured embodiment, the information required to control PBX 512 is stored in database 518 by server 516.

In the embodiment illustrated in FIG. 3, system 510 is implemented with local area network 514 interconnecting PBX 512, server 516 and database 518. Server 516 may be any suitable computer hardware programmed to provide the functions described in more detail below. Though illustrated as a single unit, server 516 need not be implemented in this fashion. Any number of hardware devices interconnected in any suitable fashion may be used to implement server 516.

Database 518 is also illustrated as a single unit separated from server 516. Database 518 represents data used by system 510 to operate and may be stored in any suitable hardware device or devices and may be organized in any suitable fashion. Database 518 may be implemented in a mass storage system separate from server 516 or may be implemented in non-volatile memory associated with server 516. Further, database 518 may be distributed, having components in one or more of PBX 512, server 516 and separate hardware devices.

For PBX 512 to route a call from caller 570 to intended recipient 550, database 518 contains a mapping between a phone number provided to caller 570 by intended recipient 550 and a phone number that PBX 512 may use to make a connection to intended recipient telephone 554. Such information may be stored in database 518 by interactions between intended recipient 550 and server 516. As shown in FIG. 3, local area network 514 may be connected to internet 530 through router 520. Such a connection provides a mechanism for intended recipient 550 to become a subscriber to the service provided through system 510. Accordingly, one function of server 516 may be to host a subscriber website, allowing intended recipients to subscribe to the service offered through system 510. A subscriber website may also allow a subscriber to configure the service offered through system 510 as described in more detail below. Any suitable programming within server 516 may be used to establish a subscriber website.

For system 510 to generate an appropriate message to caller 570, database 518 also contains information about both the content and circumstances in which messages are played to callers, such as over connection 582. To allow such information to be stored in database 518, server 516 may also be configured to host a message provider website. A message provider may provide information through the message provider website using a terminal 540 connected through internet 530. Information provided by a message provider through the message provider website may include the content of the messages as well as other information required to configure the presentation of messages to callers or to complete the transactions performed by system 510 as described in more detail below. In addition, a message provider website may also provide a mechanism for a sponsor to receive information concerning the operation of system 510, including, but not limited to, historical information detailing the presentation of messages to callers.

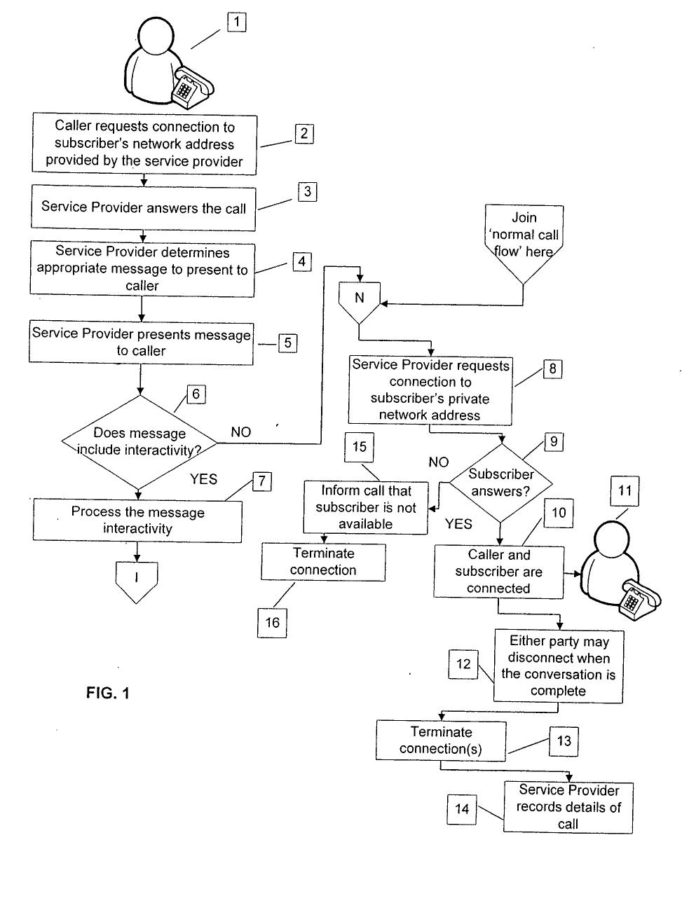

Turning to FIG. 1, an example of a method performed by the system of FIG. 3 is provided. In a normal telephone communication, party 1, herein referred to as the caller, initiates a telephone call to another party 11, herein referred to as the intended recipient, and that intended recipient typically answers the telephone call. From the perspective of the caller, there are four distinct steps to a phone call: dial, ring, communicate, hangup. The intent of this invention is to use the time that the caller would normally listen to a ringing signal during the ring step of the telephone call to present a message to the caller. This message will likely be of a promotional nature, in which an entity, herein referred to as the message provider, may proclaim the qualities or advantages of their goods or services. Of course, the message need not be of a promotional nature. Depending on the capabilities of the network interface devices being used by the caller and recipient (e.g., telephone, mobile phone, software program) the message can assume one or multiple forms, including, but not limited to, audio, video, computer software (e.g., a game), hypertext, and data (e.g., stock information, weather information, product pricing information).

In the specific case of presenting a message to a caller in the telephone system, U.S. Pat. No. 4,811,382, U.S. Pat. Application Pub. No. 2001/0051517 A1, and U.S. Pat. No. 7,006,608 describe how one can present a message in place of, or interspersed with, the ring-back signal. This ring-back signal is an audible signal effect that is the result of an inaudible “out-of-band” signal transmitted on the Signaling System #7 (SS7) line. The purpose of the ring-back is to indicate to the caller that a ringing signal is being sent to the telephone of the intended recipient to apprise the intended recipient of a potential telephone call. The mechanisms for providing a message described in U.S. Pat. No. 4,811,382, U.S. Pat. Application Pub. No. 2001/0051517 A1, and U.S. Pat. No. 7,006,608 may be used herein and such patents and applications are hereby incorporated by reference. However, this provisional application describes an alternate means of presenting a message to a caller, such that the entity that plays the message, herein referred to as the service provider, is not required to manipulate the ring-back signal of the Public Switched Telephone Network (PSTN). The method and apparatus described are also capable of playing a message to an intended recipient, or both an intended recipient and a caller.

In the embodiment illustrated in FIG. 1, the method used to accomplish message presentation is for the service provider to accept calls on behalf of an intended recipient. In the embodiment illustrated in FIG. 1, an intended recipient party enters into an agreement with the service provider whereby the intended recipient party, herein referred to as the subscriber, agrees to have callers, 1, request connections, 2, to (e.g., “dial”) a network address that is answered by the service provider in 3. This network address may be different than the address that is used to directly contact the subscriber's telecommunications interface device. Examples of telecommunications network addresses include, but are not limited to, telephone numbers, Session Initiation Protocol (SIP) addresses, and IM screen names or handles.

In an alternate embodiment of this invention, a subscriber agrees to forward all inbound calls to the service provider through software-based or other means, except for those calls that originate from the service provider. In another alternate embodiment of this invention, all inbound calls are routed through the service provider's telecommunications equipment through software-based or other means.

After accepting the call, 3, on behalf of the subscriber/intended recipient, the service provider determines an appropriate message to present to the caller, 4, band then presents a message, 5, to the caller over the connection that has been established. During the message, the caller may be given the opportunity, 6, to act on the information presented in the message by any number of means. For example, the caller may be able to press a key or otherwise interact with their telecommunications device, speak a command, message a Short Message Service (SMS) address to request more information about a product or service that was described in the message, or visit a website to obtain more information about a product or service.

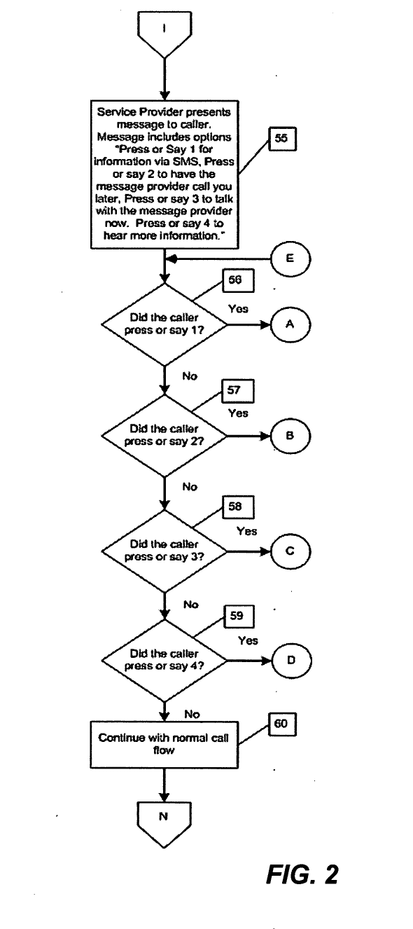

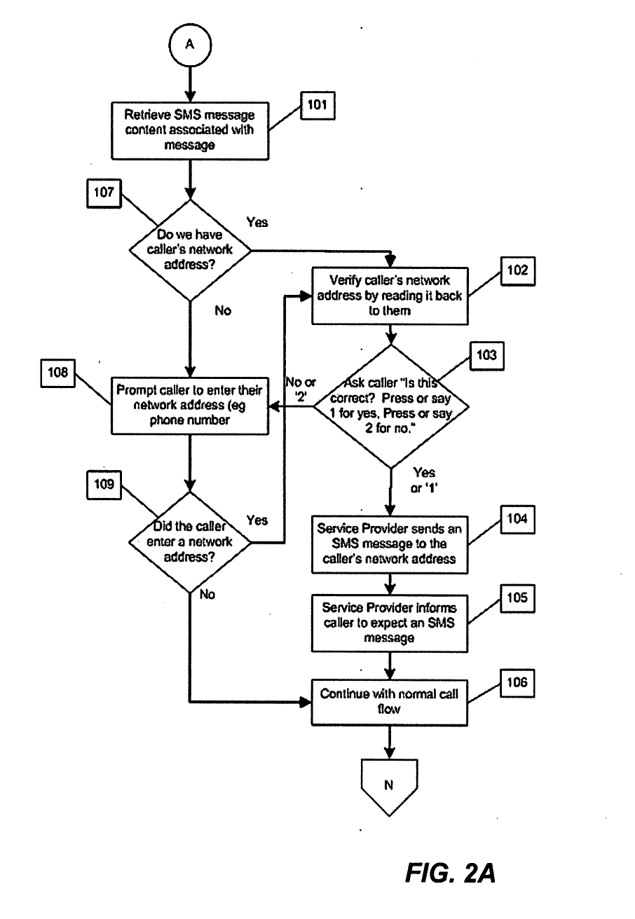

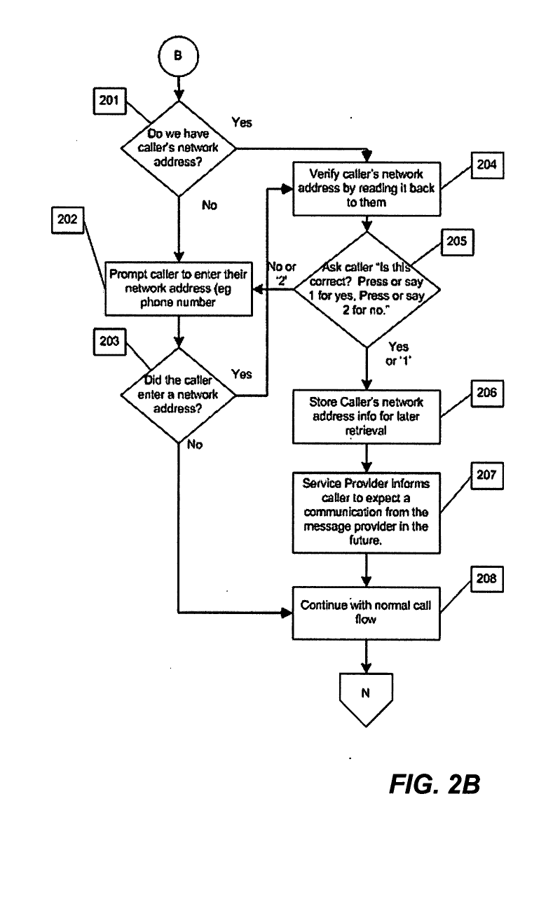

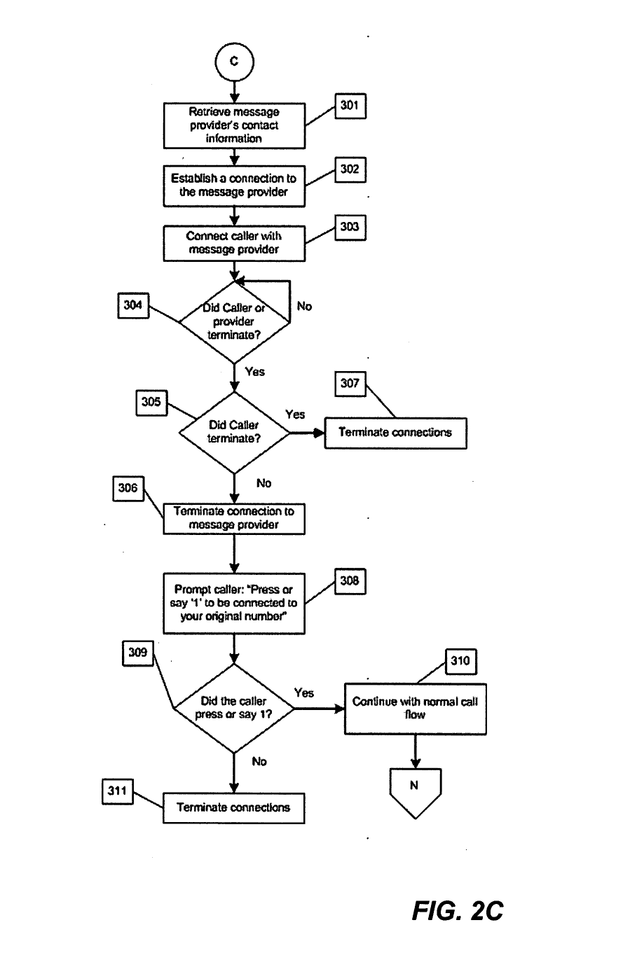

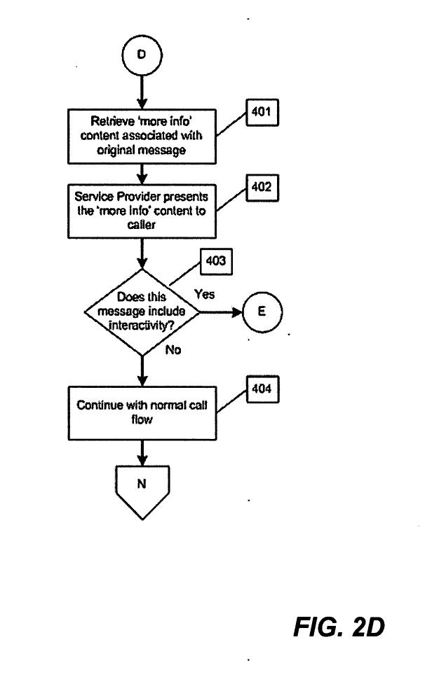

Sample methods for acting on the information presented in the message are outlined by method points A, B, C, and D in FIG. 2; the details of these methods are depicted in FIGS. 2A, 2B, 2C, and 2D, respectively. The caller may be given the opportunity to receive an SMS message (FIG. 2A), to interact with the message provider after communicating with the subscriber/intended recipient (FIG. 2B), to speak with an agent or representative of the message provider to discuss a product or service or complete a transaction (FIG. 2C), or to request additional information be presented immediately (FIG. 2D).

FIG. 2A depicts the process flow if the caller chooses to receive an SMS message. In this case, the service provider first selects and retrieves an appropriate SMS message that may be associated with the message 101 presented to caller 1. After retrieving an SMS message, the service provider then determines whether it knows the caller's network address, 107. Any suitable method for determining the network address of the caller may be used. In the example of a telephone network, the service provider can read the “caller identification” information provided by the telephone company. If the service provider determines that it knows the network address of the caller, it then presents the address to the caller by one or more means (e.g., audio, video, text), 102, and asks the caller if the address that was presented is correct, 103, by one or more means appropriate to the communication medium. In the event that the caller signals to the service provider that the address presented to the caller was incorrect, the service provider prompts the caller to communicate the correct network address to the service provider, 108. The communication of the network address to the service provider may be performed by a number of means, including, but not limited to, voice, hand writing, the caller pressing buttons on their network interface device, or a software-based query of the caller's network interface device by the service provider. This same prompt, 108, is reached when the service provider determines that it does not know the network address of the caller, 107. After prompting the caller for their network address, the service provider determines whether the caller has provided the network address through any of the means requested, 109. In the event that the caller fails to provide their network address to the service provider in an adequate time period, the service provider abandons the solicitation of the network address from the caller and the call flow returns to the sequence after 6 in FIG. 1 through pentagon N. If the event that caller successfully provides their network address through any of the means requested, 109, the service provider runs through steps 102 and 103 as described above. Whenever the caller signals to the service provider, at 103, that the address presented to the caller, at 102, is correct, then the service provider sends a message, selected at 101, to the caller, or queues it for later delivery, 104, and informs the caller to expect the future receipt of this message, 105. The necessary steps for the future message delivery action have been completed and 106 depicts the call flow returning to the call flow sequence depicted in FIG. 1 through pentagon N.

FIG. 2B depicts the process flow if the caller chooses to interact with the message provider after communicating with the subscriber/intended recipient, for example to have an agent or representative of the message provider contact the caller at a future time. In this case, the service provider determines whether it knows the caller's network address, 201. There are a number of methods for determining the network address of the caller, in the example of a telephone network the service provider can read the “caller identification” information provided by the telephone company. If the service provider determines that it knows the network address of the caller, it then presents the address to the caller by one or more means (e.g., audio, video, text), 204, and asks the caller if the address that was presented is correct, 205, by one or more means appropriate to the communication medium. In the event that the caller signals to the service provider that the address presented to the caller was incorrect, the service provider prompts the caller to communicate the correct network address to the service provider, 202. The communication of the network address to the service provider may be performed by a number of means, including, but not limited to, voice, hand writing, the caller pressing buttons on their network interface device, or a software-based query of the caller's network interface device by the service provider. This same prompt, 202, is reached when the service provider determines that it does not know the network address of the caller, 201. After prompting the caller for their network address, the service provider determines whether the caller has provided the network address through any of the means requested, 203. In the event that the caller fails to provide their network address to the service provider in an adequate time period, the service provider abandons the solicitation of the network address from the caller and the call flow returns to the sequence after 6 in FIG. 1. If the event that caller successfully provides their network address through any of the means requested, 203, the service provider runs through steps 204 and 205 as described above. Whenever the caller signals to the service provider, at 205, that the address presented to the caller, at 204, is correct, then the service provider stores the caller's network address for later retrieval, 206, and informs the caller to expect a future communication from an agent or representative of the message provider, 207. The necessary steps for a future communication from the message provider have been completed and 208 depicts the call flow returning to the call flow sequence depicted in FIG. 1 through pentagon N.

FIG. 2C depicts the process flow if the caller chooses to speak with an agent or representative of the message provider, herein referred to as the message provider for brevity, to discuss a product or service, or complete a transaction. In this case, the service provider retrieves the service provider's contact information, including a network address, 301. With this contact information, the service provider then establishes a connection to the message provider, 302. After establishing the connection with the message provider the service provider connects the caller with the message provider, 303, allowing the caller and the message provider to communicate. After making the connection, the service provider monitors the lines until it detects that either the caller or the message provider has terminated their connection, 304. If the caller terminates their connection, 305, the service provider terminates the connection it has made to each the caller and the message provider, 307. If only the message provider terminates the call, however, the service provider terminates the connection it has made with the message provider, 306, and prompts the caller to indicate whether the caller would like to be connected with the intended recipient/subscriber, 308. If the caller indicates that the caller would not like to be connected to the intended recipient at 309, then the service provider terminates the connection with the caller, 311. If the caller indicates that the caller would like to be connected to the intended recipient at 309, then 310 depicts the call flow returning to the call flow sequence depicted in FIG. 1 through pentagon N.

FIG. 2D depicts the process flow if the caller chooses to request additional information be presented immediately. In this case, the service provider retrieves a message that contains additional information that may be associated with the original message, 401. The service provider then presents a message, 402, that was chosen at 401, to the caller. If a selected message provides the caller with an opportunity to act on the information presented in the message, 403, then the call flow proceeds to circle E in FIG. 2. If a message does not provide an opportunity for the caller to act on the information presented in the message, the call flow proceeds through 404 to the call flow sequence depicted in FIG. 1 through pentagon N.

Prior to or at the end of playing the message to the caller, or after the caller has acted upon the information presented in the message, the service provider places a call to the intended recipient on a separate line, 8. If the subscriber's line is not unhooked, or remains otherwise unanswered, depicted through the ‘No’ decision path of 9, then the service provider informs the caller that the subscriber is not available, 15, and terminates the connection it has established with the caller, 16. If the subscriber's line is unhooked, or otherwise answered, as depicted through the ‘Yes’ decision path of 9, then the service provider connects the call, 10, to the intended subscriber, 11, with the call the service provider has already established with the caller such that the caller and the intended recipient can communicate with one another. The service provider may present a message to the subscriber prior to making the connection between caller 1 and subscriber 11. If either the caller or the subscriber terminates their connection, 12, then the service provider terminates the connection it has made to each the caller and the subscriber, 13. After the service provider has terminated the connections it has made to each the caller and the subscriber, it records the details of the call, 14.

In accordance with embodiments of the invention, a service provider may present a message to the caller or the recipient, or both. If the recipient, who is a subscriber in the embodiments illustrated, answers their communications device prior to the end of the message being presented to the caller, the subscriber may be presented with the message being presented to the caller. In an alternate embodiment of this invention, the service provider may delay the presentation of a message until both the subscriber and the caller are connected, thus delivering a message to both parties. In an alternate embodiment of this invention, the service provider may independently play a message to each of the subscriber and the caller prior to connecting the two parties. In this situation, the service provider may also choose to independently play a message to only the subscriber, or only the caller, prior to connecting the two parties.

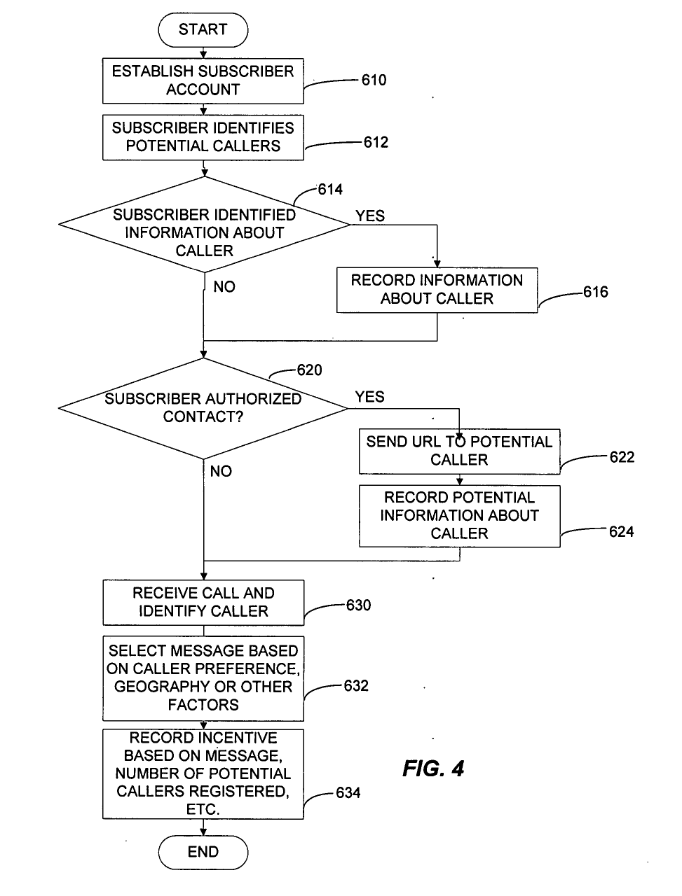

A system as described above may be used by a business that enrolls subscribers that are willing to have their callers receive messages. FIG. 4 is a flowchart of a process that may occur during the conduct of such a business. The process of FIG. 4 begins at block 610 where a subscriber establishes an account with the business. The recipient may establish an account at block 610 in any suitable way. For example, a person may enroll for this service through a web based interface. However, other means of communication between a business and a potential subscriber may be used to establish an account with the service.

As part of establishing an account, the service may designate a telephone number for the subscriber. The subscriber may provide this telephone number to potential callers. For a business using a system as depicted in FIG. 3, the telephone number provided to the recipient may initially connect to a system 510. However, based on account information, the system may associate a called number with a subscriber, allowing the system to forward calls to the subscriber.

In addition to storing information associating a subscriber with a called number, the system may also store information relating potential callers to preferences for processing calls received from those potential callers. The preferences may be stored in conjunction with a subscriber account such that the preferences will be applied based on the subscriber called.

A business may store any suitable type of preference information. For example, the type or duration of messages played for a caller may be specified as a preference. However, the nature of preferences specified for potential callers is not a limitation on the invention.

In the embodiment illustrated in FIG. 4, potential callers are identified at block 612 as a precursor to recording preferences for the potential callers. Potential callers may be identified in any suitable way. However, in the embodiment illustrated, potential callers are identified by a recipient who has established an account and is therefore a subscriber to the business. The subscriber may provide information identifying potential callers in any suitable way. For example, a subscriber may input telephone numbers from which potential callers will place calls along with an identifier for the potential caller. This information may be provided through a website or over any other suitable mechanism.

Once potential callers are identified, the process proceeds to decision block 614. At decision bock 614, the process branches depending on whether the recipient identified preferences for the potential callers as a part of identifying the potential callers. If the recipient identified preferences, the process branches to block 616. At block 615, information about the potential callers is recorded. The information may be recored in any suitable way. As one example, the preferences may be recorded in computer readable media associated with a system that provides messages to callers placing calls to the recipient.

Once the information is recorded, the process proceeds to decision block 620. Likewise, if the recipient did not identify caller preferences, the process branches from decision block 616 to decision block 620. At decision block 620, the process again branches, depending on whether the subscriber authorizes the system to contact potential callers. The authorization may be provided in conjunction with identifying the callers at block 612. However, the recipient may identify in any suitable way whether identified potential callers may be contacted by the service provider.

If the service provider was authorized to contact a potential caller, the process branches to block 622. In the embodiment illustrated, potential callers are contacted by sending an email to the potential caller. Accordingly, identification of potential callers at block 612 may include collecting an email address as part of an identification of a potential caller. However, the specific mechanism by which communications occur is not a limitation on the invention an any suitable mechanism for communicating with a potential caller may be used.

Regardless of the mechanism by which information is provided to a potential caller, the potential caller may be sent a URL identifying a website through which the potential caller may input information on a preference. The URL may be sent to the potential caller with descriptions or instructions that encourage and/or enable the potential caller to provide information to the service provider. In the example illustrated in FIG. 4, an email sent to the potential caller will include the URL in a link, which the potential caller may activate to connect to a web page configured to receive preferences for the potential caller. In such an embodiment, the URL may be an ephemeral URL, creating a link to a temporary web page established for one potential caller. That website may, for example, present options to the subscriber caller on the types of messages that the potential caller will hear when calling a recipient who identified that potential caller. For example, a potential caller may be given an option to hear messages relating to restaurants, sporting events, promotions offered by local retails establishments or information of other categories. However, information about potential callers may be collected in any suitable way.

Regardless of how potential caller preferences are obtained, the process proceeds to block 624. Block 624, the information about potential caller are recorded. Processing at block 624 maybe performed in the same fashion as processing in connection with block 616. However, the information may be recorded at block 624 in any suitable fashion.

After information about the potential callers are recorded, the information may be used in processing calls from that potential call. Accordingly, the example of FIG. 4 shows the process proceeding from block 624 to block 630, which begins a sub-process of responding to a call directed to the recipient. If the recipient did not authorize contact with the potential caller, processing at blocks 622 and 624 may be omitted. Accordingly, the example in FIG. 4 shows processing proceeding from decision block 620 to block 630 if contact for a potential caller was not authorized. Regardless of the path by which processing reaches block 630, at block 630 a call is received and the caller is identified. Any suitable mechanism may be used to identify a caller. However, in the embodiment illustrated, caller ID information provided by a telephone company may be used to identify a caller. In the embodiment illustrated, the caller ID information may be matched to identification information provided in block 612.

Regardless of how the caller is identified, the process proceeds to block 632. At block 632, a message to deliver to the caller is selected. In the embodiment illustrated, the messages selected, at least in part, based on caller preferences, if caller preferences have been provided. For example, if a caller has specified a preference for receiving information about sporting goods, the message selected at block 632 may relate to sporting goods. Alternatively, if the caller preference relates to books, the message selected at block 632 may advertise a sale a bookstore.

The criteria for selecting a message at block 632 may include factors in addition to or instead of caller preferences. For example, a message may be selected based on the callers geography or other factors. In the embodiment illustrated, geography may be based on information input at block 612 identifying a potential caller. Alternatively, geography may be based on information input at block 616 or 624 as a user preference. Alternatively or additionally, geography may be based on the number from which the caller has placed a call. An area code of a telephone number or other address information indicating a source address in a communication may identify a geography of the caller. In embodiments in which messages are selected based on geography, a message relevant to a caller in the geography that is the source of a call may be provided. For example, using geography information may allow a caller to hear messages about local restaurants or retail establishments. Regardless of how the message is selected, the selected message is sent to the caller.

The process then continues block 634 where an incentive is recorded for the recipient who is a subscriber to the business providing messages to callers. In some embodiments, the incentive may be a fixed incentive per call processed. However, in other embodiments, the incentive might be variable and may be based on the type of message selected or other factors. The incentive recorded may be recorded in conjunction with the recipients account. The incentive may be a monetary or other type of reward that incentivizes the recipient to identify potential callers to the system and provide information on preferences for those potential callers. Accordingly, in some embodiments, the incentive recorded at block 634 may be based on factors other than the type of message sent to the caller. As one example, the incentive may be based on the total number of potential callers enrolled by a subscriber.

Accordingly, a system as described above may be used in the performance of a business operating according to the process of FIG. 4. However, such a system may be used in conjunction with a business performing different or additional processes. A plan for a business using a system according to an embodiment of the invention is presented below.

### Operational Plan: Brring

The following is a plan for a business using an embodiment of the invention to offer a service. The service is referred to herein as “Brring,” which is one example of an embodiment of the invention.
Summary: Sell your ring back tone. Callers hear a brief sponsored message before connecting to you. Get paid for every message that your callers hear.
Registration: Register for service via Web.
   Confirm registrant location (zip), other desired demographic info (age and gender), and language preference (default English).
   Confirm they are who they say they are; defeat machine registration/other security measures
      Confirm via automated phone call (or SMS) to registered number (e.g., phone is dialed and automatic message says ‘Welcome to [Service Name]. Press [random number] now to confirm registration.’ If correct number is pressed the account is activated.)
         If confirmation takes place by voice communication, registrant may personalize an outbound message preface for their inbound callers, e.g., “This is [name]; check out this message while our call connects.”
         Registrant may also personalize outbound message to friends alerting them to new phone number and encouraging use (see “Registrant is encouraged to share new number” below).
   Consider request for bank account or other mechanisms to receive payment.
   Note that Registrant retains existing service provider, calling plan, handset, and telephone number, but is given a new number by Brring. Calls must be made to this new number for the Call Recipient/registrant to receive reward benefits. Calls to the new number will be forwarded to the old existing number.
      Service Limitations
   Initial service will not support toll-free (800, 888, etc.) or 900 numbers.
   Do not support numbers outside USA for initial prototype.

Registrant is encouraged to share the new number with friends and other callers.
During registration, provide forms, formats and processes to facilitate notification of new phone number. Options include:
   Email and/or Instant Message. May facilitate by automatically pulling in contact information from address books of popular email programs and services; buddy lists from IM program at Registrant's request.
   Automated phone call. Registrant can record a message and have it dialed out to a list he/she provides. This may take place during the confirmation/activation process. Advantage to this approach is the message can be dialed out from new number, so that it shows up in friends' caller ID. Part of message can be to remind friend to save new number in phone using the caller ID that has just appeared on their device. May also provide opportunity for additional account recruitment, e.g., “I'm getting paid! You can too at [servicename.com].”)
   Text messages to handsets.

Registrant prioritizes sponsorship types he/she believes will be most appealing to his/her callers.
Allow Registrant to prioritize universally across callers.
   Example Categories:
      Consumer Electronics
      Apparel
      Toys/Video Games
      Food/Beverage
      Entertainment
      Health/Beauty
If they input friends' numbers, provide option to prioritize on a caller-by-caller basis.
   Also allow callers to set their own preferences
      1) Upon invitation by Registrant. Example: Person A has registered with Brring and has set preferences for incoming call numbers, including those belonging to Person B. A sends B a message saying “call me on this new number, and by the way, if you would like to adjust your interest preferences you can do so” and sends a single use expiring URL that allows B to make modifications.
      2) Brring registrants can set their own preferences, should they to call another registrant.

Call Recipients may register for the service via other interfaces and protocols, such WAP, with similar workflow modified as necessary.

Incentives for Joining:

Rewards are earned on a per ad served basis.

Rewards are also earned for other behavior, such as:
Referring new registrants
Longevity (being part of the service for six months, a year, etc.)
High “call through” among their callers
High rate of prioritization for their callers (meaning registrant sets individualized preferences for their callers on a number-by-number basis)
   Monetary Incentives
Standard incentive based on messages played to inbound callers. Present assumption is 3-5¢ per message played.
   In some embodiments, may be a deduction of reward on calls longer than 10 minutes.
Introductory incentives may be higher, and may include programs such as:
   First month, rewards of 50¢ per inbound call received (and ad served) for up to twenty different inbound numbers.
      Reward is registered after the second call received for any given number.
      High incentive rewards will not apply to incoming calls that block caller ID.
Reinforce value of rewards earned for each call received by playing a proprietary jingle (for example a cash register “ka-ching” sound) when calls are connected
Limitations to prevent gaming of system
   Policy of restricting rewards to a set number of calls per month from a given inbound calling number. For example, the set number may be five, but in other embodiments may be 7 or 10. This parameter may be set by the advertiser.

Subscribers May be Offered Cash or Non-cash incentives.

Examples of non-cash incentives include:
Free phone minutes
   Partner with carriers to get credits on their incumbent bill.
   Unlikely to use free minutes as non-cash reward in near term.
Merchandise from sponsors via rewards programs (allow them to get more “value” for not taking cash).
Brring “points,” which would have a cash equivalent value.
   Redemption of Incentives

Rewards may be donated or gifted to third parties, such as charities, political organizations, or other groups. This preference may be indicated at the time of registration, particularly if the Registrant was referred by a partner (e.g., the United Way). Alternatively, the designation may take place at the time of redemption.
Rewards redeemable through Brring Web site and/or fulfillment partner websites. Points could be used as credits with fulfillment partners, who might include widely horizontal online retailers (e.g., Amazon, etc.)
Gift cards
Rewards redeemable through phone, e.g., downloadable game, application, or ringtone
Direct deposit
Must provide Registrants way to check status of their rewards/incentives online. Want them to be able to see accrual of rewards.
   Opt-In/Permission Marketing:
Call Recipient opts-in
   Customizing/prioritizing ads that play back to his/her callers
      by class e.g., “entertainment/leisure,” “technology,” etc.
      specific advertisers
      Possibly opting out of particular advertisers or types (maybe)
Callers opt-in by choosing to listen to or respond to message.
   May upon invitation by Registrant adjust their own preferences. One way in which this may be accomplished is the following way. Person A has registered with Brring and has set preferences for incoming call numbers, including those belonging to Person B. A sends B a message, possibly via email, saying “call me on this new number, and by the way, if you would like to adjust your interest preferences you can do so” and includes a single use expiring URL that allows B to make modifications.
   Registrant Customizing/prioritizes the ads that they would hear should they call another Brring registrant.
      Phone Number Assignment and Call Flow

New phone numbers are assigned to Call Recipients who register with Brring.
In some embodiments, these Call Recipients could use their existing numbers, but in the presently described embodiment we assign a new number. In other embodiments, we may selectively exempt a designated phone number from call forwarding and in this way Call Recipients can use their existing number.
   Calls to new numbers are received by Brring.
      An appropriate (as prioritized by Call Recipient) sponsored ring back message is played for the Caller.
      Message can be short, for example less than 10 s.
      Caller is given options to take action
         Example for illustration purpose:
         This message is brought to you by (MovieLink/Dell/Dominos).
         If you would like 15% off your next (movie ticket purchase/Dell purchase/delivery from Dominos) press 1 for more details.
         To connect with (MovieLink/a Dell representative/your local Dominos) right now, press 2.
         For a text message instead, press 3.
         To skip, press #.”
            We ‘hand off’ the call when caller wants to be connected with sponsor or hear more about the offer;
            We generate/enable appropriate SMS when caller selects this action.
            Brring may or may not reconnect with the original call if the caller chooses to hear advertisement.
      Brring must track all ads, which ones were skipped, acted on, etc. Record those who choose to receive SMSs etc. These are made available to the advertisers via secure message provider Web interface or API.
   Calls (that have not chosen an alternate path offered by sponsor) are forwarded by Brring to call recipient's original registered phone number.
      We start the connection to the Registrant/recipient's phone while there are four to six seconds remaining in the sponsor message. This cuts down the wait time for the caller as it takes approximately this long for the phone network to make the connection.
         Ad Management Platform

A web-based platform allows message providers to manage their ad campaigns.
To check available inventory and prices
To choose when to run campaigns; which incoming area codes, other demographics; duration, days and dates and time of day; rules about min and maximum frequency, etc.
To get instruction on best practices as well as upload audio clips
To track results and reports.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” as used herein is intended to mean “based, at least in part, on” unless explicitly stated otherwise. Also, the phrase “call” as used herein is intended to mean “telecommunications session” unless explicitly stated otherwise.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, magnetic disks, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a telecommunication system, the method: comprising
receiving a call from a caller, the call being directed to a recipient;
providing a message to the caller prior to establishing a connection between the caller and the recipient;
recording an incentive for a party authorizing the message; and
establishing the connection.

2. The method of claim 1, wherein recording an incentive comprises recording an incentive for the recipient, the incentive having a value based on the content of the message.

3. The method of claim 1, wherein:
the method further comprises, at a first time, the first time being prior to receiving a call directed to the recipient, enrolling the recipient as a subscriber; and
recording an incentive for the recipient comprises recording a value based on a number of calls directed to the recipient between the first time and the time the call is received.

4. The method of claim 1, wherein providing the message comprises providing a promotional message.

5. The method of claim 4, further comprising:
entering into an agreement with a sponsor; and
receiving content for the promotional message from the sponsor.

6. The method of claim 5, further comprising recording a charge to the sponsor in response to providing the message.

7. The method of claim 1, further comprising:
receiving, in connection with the call, information identifying a geographic location of the caller; and
selecting the message based on the geographic location.

8. The method of claim 1, further comprising:
receiving, in connection with the call, information identifying the likely interests of the caller; and
selecting the message based on the likely interests.

9. The method of claim 1, further comprising:
providing the recipient with access to information on the recorded incentive.

10. A method of operating a telecommunication system for which a sponsor provides promotional information, the method comprising:
receiving a call from a caller, the call being directed to a recipient;
providing a message to the caller prior to establishing a connection between the caller and the recipient, the message having content based on the promotional information; and
prompting the caller for input based on the message.

11. The method of claim 9, further comprising:
receiving input from the caller; and
in response to the input, establishing a connection between the caller and the sponsor.

12. The method of claim 9, further comprising:
receiving input from the caller; and
in response to the input, sending an SMS message to the caller.

13. The method of claim 9, further comprising:
receiving input from the caller; and
in response to the input, notifying the sponsor to contact the caller.

14. The method of claim 9, further comprising:
receiving input from the caller; and
in response to the input, providing more information to the caller about the sponsor.

15. The method of claim 9, further comprising:
connecting the caller to the recipient.

16. A method of operating a telecommunication system, the method comprising:
establishing an account associated with a recipient;
recording, in connection with the account, information about a plurality of potential calling parties;
receiving a call from a caller, the call being directed to the recipient and the caller being a party of the plurality of potential calling parties;
providing a message to the caller prior to establishing a connection between the caller and the recipient, content of the message being based on the information; and
establishing the connection.

17. The method of claim 16, wherein recording the information comprises receiving from each of the plurality of potential calling parties at least one preference relating a type of promotional information.

18. The method of claim 17, further comprising, sending an e-mail to each of the plurality of potential calling parties with an expiring URL, the URL providing a link to a web page through which changes to the recorded information may be made.

19. The method of claim 16, wherein recording the information comprises receiving from the recipient at least one preference relating a type of promotional information for at least a portion of the plurality of potential calling parties.

20. The method of claim 16, further comprising:
recording an incentive for the recipient, the incentive being related to the number of the plurality of potential calling parties.

21. The method of claim 20, wherein recording an incentive comprises recording a cash reward, a credit for free phone minutes and/or a merchandise credit.
